(19) United States
(12) Patent Application Publication
(10) Pub. No.: US 2013/0175208 A1
(43) Pub. Date: Jul. 11, 2013

(54) FILTRATION APPARATUS

(71) Applicant: Grundfos BioBooster A/S, Bjerringbro (DK)

(72) Inventors: Steffen MADSEN, Hollandsbjerg (DK); Yuan BIN, Suzhoug (CN)

(73) Assignee: GRUNDFOS BIOBOOSTER A/S, Bjerringbro (DK)

(21) Appl. No.: 13/736,355

(22) Filed: Jan. 8, 2013

(30) Foreign Application Priority Data
Jan. 9, 2012 (EP) 12 000 117.7

(51) Int. Cl. C02F 3/02

(52) U.S. Cl. CPC C02F 3/02
USPC 210/151; 210/330

(57) ABSTRACT

A filtration apparatus (2) includes a pressurized cylindrical pressure vessel (4) having a longitudinal axis (X) and a shaft (8) having a longitudinal axis (Y) extending parallel to the longitudinal axis (X). A plurality of rotatable membrane filter discs (6) are arranged along the shaft (8). The membrane filter discs (6) are spaced-apart from each other, attached to the shaft (8) and oriented transverse to the longitudinal axis (Y) of the shaft (8). An interior (10) of the membrane filter discs (6) are in fluid communication with a permeate discharge channel (12) extending parallel to the longitudinal axis (X) of the pressure vessel (4). The pressure vessel (4) has a cylindrical inner geometry without any significant obstruction elements. The longitudinal axis (X) of the pressure vessel (4) is laterally offset from the longitudinal axis (Y) of the shaft (8) and/or the membrane filter discs (6) are oval-shaped.

### BACKGROUND OF THE INVENTION

The present invention relates generally to a filtration apparatus. The present invention more particularly relates to a pressurized filtration apparatus using ultra filtration membranes to filter activated sludge.

A membrane bioreactor (MBR) combines a membrane process with a suspended growth bioreactor. The membrane process may, by way of example, be microfiltration or ultra filtration. MBR technologies are widely used for industrial and municipal wastewater treatment.

When MBR techniques are used for filtration of sludge, fouling of the membranes is a major challenge. Fouling of the membranes will reduce the filtration capacity and thus slow down the process time and increase the cost.

A common way of reducing fouling of the membranes is to use cross flow filtration where a flow across the filter surface is used to reduce and, at least partly, tear off the fouling layer. Hereby it will become possible to maintain a higher permeate flow.

The cross flow depends on the velocity relative to the membrane surface and the cross flow influences the shear stress on the membrane.

The strain rate, γ, also called the velocity gradient perpendicular to the direction of shear is defined as the ratio between velocity change and distance between adjacent layers of different velocities:

γ=dv/dy (1)

The shear stress, τ, is the product between viscosity, η, and strain rate, γ, and is given by:

τ=η·γ (2)

Viscosity is almost constant for a Newtonian fluid like water, but for a non-Newtonian fluid like sludge, the viscosity is decreasing for increasing strain rates.

Establishment of a higher cross flow can be provided by introducing significant obstruction elements outside the rotating membrane disc for creating turbulences and shear. A higher cross flow can also be introduced by arranging rotating shear generating elements between the stationary membrane discs. Both the obstruction elements and the rotating shear generating elements are associated with a more complex construction.

Accordingly, there is a need for a simple way of generating a higher cross flow and hereby shear on a membrane surface.

### BRIEF SUMMARY OF THE INVENTION

It is an objective of a preferred embodiment of the present invention to specify a filtration apparatus that provides a higher cross flow and shear on a membrane surface.

The above objective can be achieved by a filtration apparatus having a pressurised cylindrical pressure vessel having a longitudinal axis, a shaft having a longitudinal axis extending parallel to the longitudinal axis of the pressure vessel, and a plurality of rotatable membrane filter discs arranged along the length of the shaft. The membrane filter discs are spaced from each other attached to the shaft and oriented transverse to the longitudinal axis of the shaft and the interior of the membrane filter discs are in fluid communication with a permeate discharge channel. The channel extends parallel to the longitudinal axis of the pressure vessel. The pressure vessel has a cylindrical inner geometry without any significant obstruction elements. The longitudinal axis of the pressure vessel is laterally offset from the longitudinal axis of the shaft and/or that the membrane filter discs are oval-shaped. Improved embodiments are disclosed in the following description and the drawings.

Hereby higher shear can be achieved and thus fouling of the membranes can be reduced so that a higher permeate flow can be maintained. The eccentric position of the discs relative to the vessel or the oval shape of the discs generates a flow pattern that in some areas will be directed against the rotation direction of the disc so that high shear can be achieved. More specifically it has been found, that shifting the longitudinally extending axis of the discs away from the longitudinally extending axis of the vessel, or by making the discs oval in shape, generates a multiple of swirls in the wastewater. Each of these swirls rotates clockwise or counter clockwise and essentially stay in their position in the waste water once they have been generated. When a disc is moved through these swirls they act abrasively on the surface of the disc.

By the term pressurised is meant that the pressure in the pressure vessel exceeds the pressure from the surroundings. It is preferred that the pressure in the vessel is 1-4 bars above the pressure from the surroundings. An increased pressure in the pressure vessel will cause an enhanced aeration and thus enable treatment of a larger volume fluid per time unit.

The membrane filter discs may be made in any suitable material e.g. ceramics, metal, or polymer.

It may be an advantage that the membrane filter discs are basically oval or circular.

By having oval-shaped membrane filter discs higher shear can be achieved due to the flow patterns introduced by the oval-shaped membrane filter discs.

The oval-shaped membrane filter discs may be arranged in different ways along the length of the shaft. All the membrane filter discs may be oriented in the same way, however, it is possible to arrange the filter discs so that every second disc is arranged in one way and that adjacent discs are angular displaced (e.g. 90 degrees) relative to one another.

When adjacent discs are angularly displaced (e.g. 90 degrees) relative to each other, it is possible to arrange the discs closer to one another and still be able to operate the filtration system, even though the sludge that is drained along the radius of the filtration discs is being concentrated along its way along the radius of the filtration discs. There may be space enough for the sludge to escape from the intermediate space between adjacent filter discs because all adjacent oval filter discs are angularly displaced.

It is preferred that the longitudinal axis of the pressure vessel is laterally offset from the longitudinal axis of the shaft with a distance corresponding to 2-20%, preferable 5-10% of the inner diameter of the pressure vessel. By having an eccentricity corresponding to 2-20%, preferable 5-10% of the inner diameter of the pressure vessel an effective shear distribution is achieved along the discs so that fouling of the membranes can be significantly reduced.

It may be an advantage that the shaft comprises a plurality of interconnected shaft portions, that the shaft extends along the length of the pressure vessel and that the shaft is mechanically connected to a drive unit.

In this way it is possible to build filtration apparatuses of various lengths by selecting, interconnecting, and arranging a suitable number of shaft portions along the entire length of the pressure vessel and connect the shafts to a drive unit. Besides it is possible to build the filtration apparatus from filter modules each rotatably mounted to a shaft portion.

Preferably, the drive unit is an electronic motor that may be equipped with a frequency converter for changing the rotational speed of the shaft. A good shear effect has been found in the range of 100 to 250 RPM, preferably between 140 and 200 RPM.

It may be an advantage that the shortest distance, D₁, between the membrane filter discs and the inner side of the pressure vessel is less than half the longest distance, D₂, between the membrane filter discs and the inner side of the pressure vessel so that D₁<½D₂. By reducing D₁ and increasing D₂ the highest possible eccentricity can be achieved in order to generate the highest possible shear.

It is preferred that one or more porous aeration pipes extending basically parallel to the longitudinal axis of the pressure vessel are arranged on the inner side of the pressure vessel.

The porous aeration pipes are pipes provided with holes, through which air or gas can be delivered to the fluid being filtered. Porous aeration pipes arranged on the inner side of the pressure vessel makes it easier to dissolve oxygen containing gas into the fluid.

It may be beneficial that the filtration apparatus includes a plurality of membrane filter disc modules each consisting of a stack of membrane filter discs, and that a bearing is provided at the connection area of each set of adjacent membrane filter disc modules.

Use of membrane filter disc modules including a stack of membrane filter discs makes it possible to build filtration apparatuses of different lengths. Thus, it is possible to meet specific customer demands. Furthermore, replacement of filter discs can be eased. It is an advantage that a bearing is provided at the connection area of each set of adjacent membrane filter disc modules, because this makes it easier to build and assemble the filtration apparatus. By the term connection area is meant the area located between sets of adjacent membrane filter disc modules. Adjacent membrane filter disc modules is neighbouring filter disc modules.

It is preferred that the membrane filter disc modules are arranged in a chassis part extending along the length of the pressure vessel. Hereby it is possible to arrange all membrane filter disc modules at a chassis part and hereafter arrange the chassis part and the membrane filter disc modules as one unit in the vessel.

It may be an advantage that each filter disc is arranged in such a way that the filter discs are arranged in such a way that a line L that intersects a first filter disc point P₁ that has the shortest distance, D₁, to the inner side of the pressure vessel and that said line intersects a second filter disc point P₂ that has the longest distance, D₂, to the inner side of the pressure vessel. The line L then defines:

a first 180 degree angular area comprising:
1) a first 90 degree angular area A₁ abutting the first point P₁ and
2) and a second angular area A₂ abutting first 90 degree angular area A₁ and being present at the same side of the line L as first 90 degree angular area A₁,

a second 180 degree angular area comprising:
3) a third 90 degree angular area A₃ abutting the second 90 degree angular area A₂ and being present at the opposite side of the line L as the second 90 degree angular area A₂, and
4) and a fourth degree angular area A₄ extending between the third 90 degree angular area A₃ and the first 90 degree angular area A₁,

where one or more porous aeration pipes extend in the third 90 degree angular area A₃.

In this way it is possible to achieve high shear at the presence of the porous aeration pipes. When the aeration pipes are located in the third 90 degree angular area optimum conditions are present for allowing air bubbles, released from the aeration pipes, to be dissolved in the fluid. The air bubbles will have the longest possible retention time in the fluid when the aeration pipes are located in the third 90 degree angular area.

It is preferred that no porous aeration pipes extend in the first 90 degree angular area or in the second 90 degree angular area because this will make it possible to achieve the highest possible shear.

It may be beneficial that the pressure vessel is configured to function as a membrane bioreactor (MBR) and that one or more porous aeration pipes, extending basically parallel to the longitudinal axis of the pressure vessel arranged on the inner side of the pressure vessel are configured to aerate a fluid contained in the pressure vessel. Hereby it is possible to use the vessel as a biological reactor and filtration unit at the same time.

It is preferred that the porous aeration pipes are configured to release air bubbles in a size range of 2-40 μm, preferable 5-10 μm. Such aeration pipes provide air bubbles that can easily be dissolved in the fluid and hereby be utilized by aerobic bacteria.

Other objectives and further scope of applicability of the present invention will become apparent from the detailed description given hereinafter.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of a filtration apparatus according to a first preferred embodiment of the present invention;

FIG. 2 is a cross-sectional view of a part of the filtration apparatus according to the present invention;

FIG. 3 is another cross-sectional view of the filtration apparatus according to the present invention;

FIG. 4 is a schematic view of a waste water treatment system with the filtration apparatus according to the present invention, and

FIG. 5 is a schematic view of a shear stress distribution on the filtration membrane in the filtration apparatus according to the present invention.

### DETAILED DESCRIPTION OF THE INVENTION

Certain terminology is used in the following description for convenience only and is not limiting. The word “outwardly” refers to a direction away from the geometric center of the device, and designated parts thereof, in accordance with the present invention. Unless specifically set forth herein, the terms “a,” “an” and “the” are not limited to one element, but instead should be read as meaning “at least one.” The terminology includes the words noted above, derivatives thereof and words of similar import.

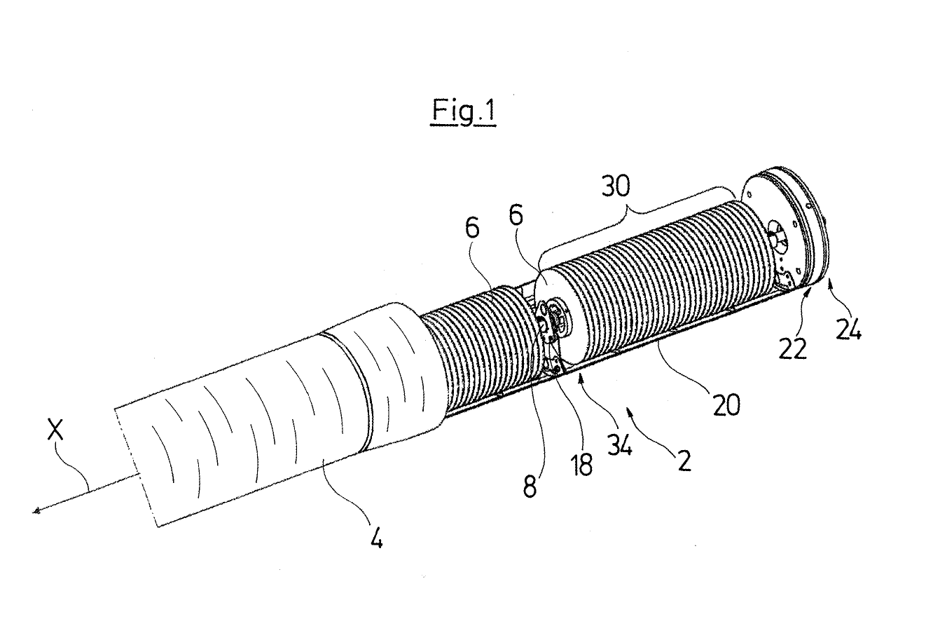

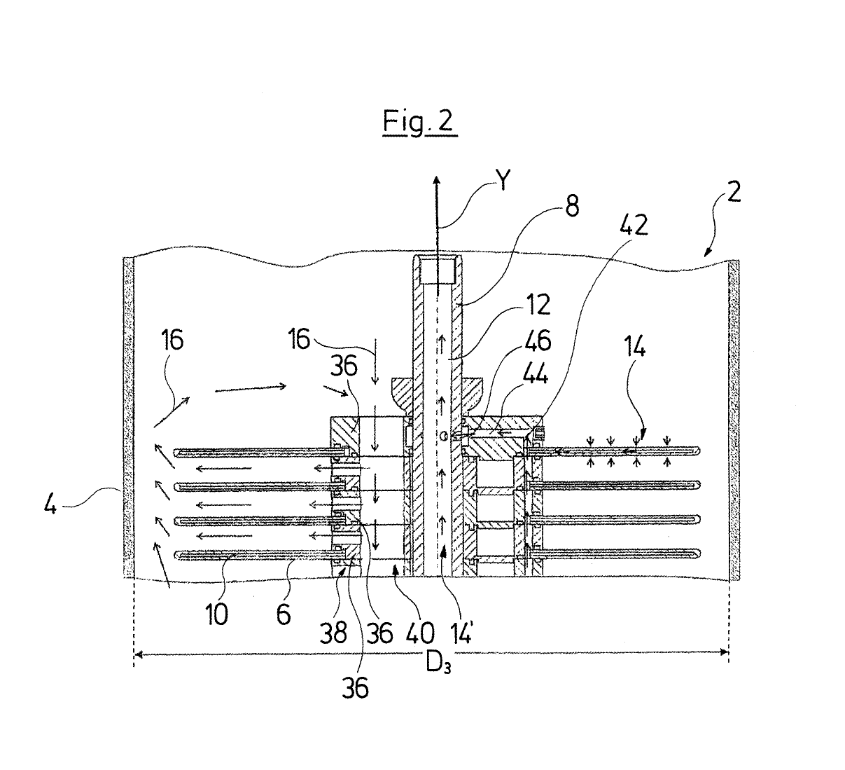

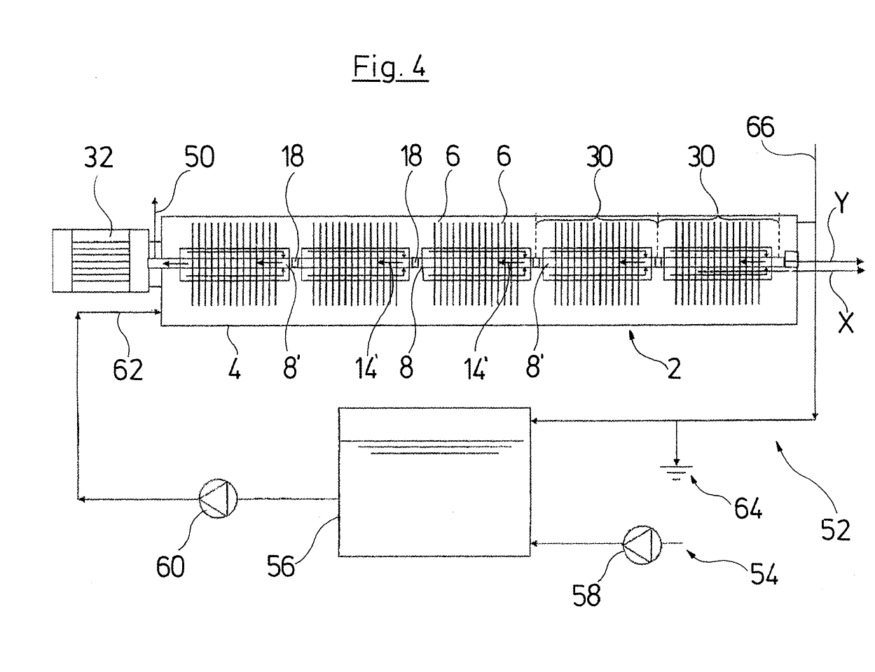

Referring to the drawings in detail, wherein like numerals indicate like elements throughout the several views, FIG. 1 illustrates a filtration device or apparatus 2 including a pressurised cylindrical pressure vessel 4 having a longitudinal axis X. Inside the vessel 4 a shaft preferably extends parallel to the longitudinal axis X of the pressure vessel 4 and a plurality of rotatable membrane filter discs 6 are preferably arranged along the length of the shaft 8. The membrane filter discs 6 are basically evenly spaced from each other and they are attached to the shaft 8 and oriented transverse to the longitudinal axis Y (see FIG. 2) of the shaft 8 that is mechanically connected to a drive unit 32 (see FIG. 4).

The filtration device 2 preferably includes several modules 30 each comprising a stack of membrane filter discs 6. The modules 30 are arranged in a chassis part 20 that extends along the length of the pressure vessel 4. A bearing 18 is provided at the connection area 34 of each set of adjacent membrane filter disc modules 30. The bearing 18 is attached to the shaft 8. At the distal end of the shaft 8 an end flange 24 with a sludge inlet 22 is provided. The end flange 24 with the sludge inlet 22 can be fixed to the chassis part 20.

The shaft 8 includes a number of interconnected shaft portions and it is preferred that each membrane filter disc module 30 has its own shaft portion.

The vessel 4 is a pressurised cylindrical pressure vessel 4 that can be made in plastic material or any other suitable material. The required thickness of the vessel 4 may be determined on the basis of the specific pressure requirements.

When the filtration apparatus 2 is made out of a number of membrane filter disc modules 30 each having their own shaft portion, there is huge design freedom to build a filtration apparatus 2. It is possible to build filtration apparatuses 2 of various lengths by changing the number of membrane filter disc modules 30 and shaft portions.

The membrane filter discs 6 can be mounted on a shaft portion to constitute a first membrane filter disc module 30 that can be connected to the chassis part 20. Hereafter another membrane filter disc module 30 can be connected to the first membrane filter disc module 30 and to the chassis part 20. When the desired number of membrane filter disc modules 30, are connected to the chassis part 20, the chassis part 20 can be inserted into the vessel 4.

During service, the chassis part 20 with the membrane filter disc modules 30 can be pulled out of the vessel 4 and service can be carried out. It is, by way of example, possible to replace a whole membrane filter disc module 30 or disassemble a membrane filter disc module 30 in order to replace one or more membrane filter discs 6.

FIG. 2 illustrates a cross-sectional view of the filtration apparatus 2 according to a preferred embodiment of the invention. A plurality of membrane filter discs 6 are fixed to a hub member 38 comprising a plurality of mechanically connected hub segments 36.

The membrane filter discs 6 are arranged along the length of a hollow shaft 8. The membrane filter discs 6 are spaced apart from each other. The interior 10 of the membrane filter discs 6 are in fluid communication with a permeate discharge channel 12 extending parallel to the longitudinal axis of the pressure vessel 4. The pressure vessel 4 has a cylindrical cross-sectional geometry and does not have any significant obstruction elements.

The membrane filter discs 6 are capable of filtering fluid. The fluid that enters the membrane of the membrane filter discs 6 flows towards the shaft 8. This is indicated by arrows representing the permeate flow 14. The permeate hereafter flows along a channel 42 extending parallel to the shaft 8. The fluid enters the permeate discharge channel 12 in the shaft 8 via a radial channel 44 through a bore in the shaft 8. The permeate flows towards the permeate outlet 50 (see FIG. 4).

The rotation of the membrane filter discs 6 generates a sludge flow 16. The sludge flows along the channel 40 in the hub member 38 and flows hereafter outwards in a direction basically parallel to the surface of the membrane filter discs 6. Hereby the rotation of the membrane filter discs 6 generates a flow that ensures a continuous mixing of the sludge.

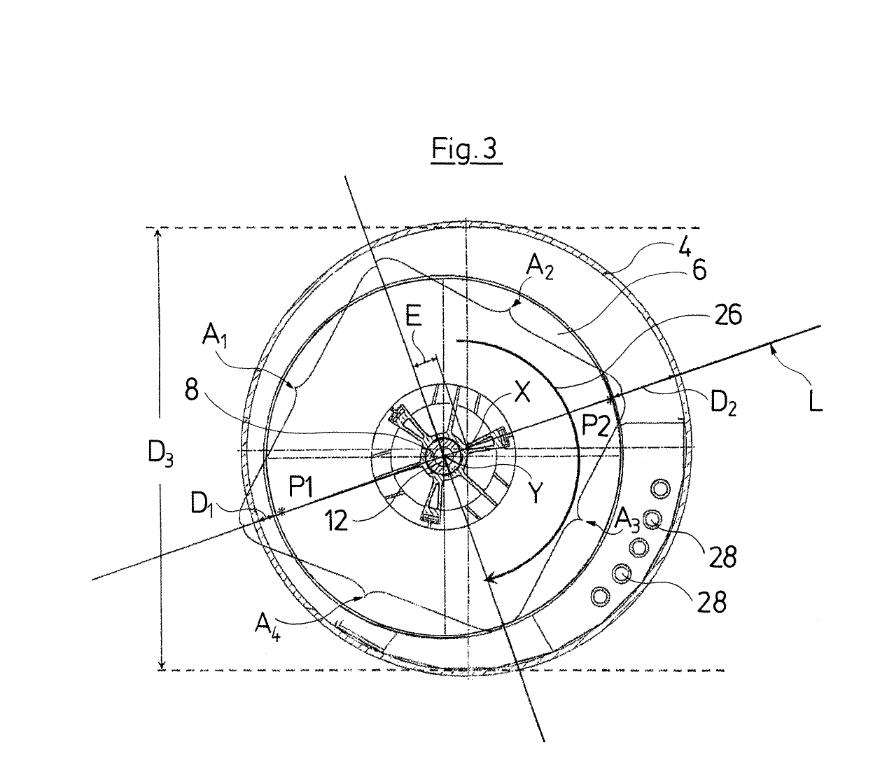

FIG. 3 illustrates a cross-sectional view of the filtration apparatus 2 according to a preferred embodiment of the invention. A membrane filter disc 6 is attached concentrically to a shaft 8 arranged in a cylindrical pressure vessel 4. The pressure vessel 4 has a longitudinal and concentric axis X.

The longitudinal axis X of the pressure vessel 4 is laterally offset from the longitudinal axis Y of the shaft 8 with a distance E corresponding to less than 10% of the inner diameter D₃ of the pressure vessel 4. The eccentricity E is indicated as the distance between the longitudinal axis X of the pressure vessel 4 and the longitudinal axis Y of the shaft 8.

Due to the fact that the longitudinal axis X of the pressure vessel 4 is laterally offset from the longitudinal axis Y of the shaft 8 the membrane filter disc 6 is will generate an increased flow across the filter surface. Accordingly, fouling of the membrane can be reduced and preferably the increased cross flow can at least partly, tear off the fouling layer so that a higher permeate flow can be maintained.

The shortest distance D₁, between the membrane filter disc 6 and the inner side of the pressure vessel 4 is less than half the longest distance, D₂, between the membrane filter disc 6 and the inner side of the pressure vessel 4.

The shaft 8 is hollow and comprises the permeate discharge channel 12. The direction of rotation 26 is indicated with an arrow. Five porous aeration pipes 28 are arranged close to the inner side of the pressure vessel 4. The porous aeration pipes 28 extend basically parallel to the longitudinal axis X of the pressure vessel 4.

The porous aeration pipes 28 are pipes provided with holes that are configured in such a way that air or gas can be delivered to the fluid through these holes. Accordingly, the porous aeration pipes make it easier to dissolve oxygen containing gas into the fluid.

The filter disc 6 has a first filter disc point P₁ that has the shortest distance, D₁, to the inner side of the pressure vessel 4. The filter disc 6 also has a second filter disc point P₂ that has the longest distance, D₂, to the inner side of the pressure vessel 4. The filter disc 6 is arranged in such a way that the line L that intersects the first filter disc point P₁ and the second filter disc point P₂, divides the filter disc 6 into a first 180 degree angular area and a second 180 degree angular area.

The first 180 degree angular area comprises a first 90 degree angular area A₁ abutting the first point P₁. The first 180 degree angular area also comprises a second angular area A₂ being present at the same side of the line L as first 90 degree angular area A₁ and abutting the first 90 degree angular area A₁.

The second 180 degree angular area comprises a third 90 degree angular area A₃ being present at the opposite side of the line L and abutting the second 90 degree angular area A₂. The second 180 degree angular area moreover comprises a fourth 90 degree angular area A₄ extending between the third 90 degree angular area A₃ and the first 90 degree angular area A₁.

Five porous aeration pipes 28 extend in the third 90 degree angular area A₃. The aeration pipes 28 are configured to aerate the fluid in the pressure vessel 4. Accordingly, the pressure vessel 4 is capable of being used as a MBR.

The porous aeration pipes 28 are configured to release small-sized air bobbles to the fluid in the pressure vessel 6.

FIG. 4 illustrates a schematic view of a wastewater treatment system 52 with the filtration apparatus 2 according to a preferred embodiment of the present invention. The waste water treatment system 52 comprises a waste water inlet 54 in fluid communication with a biological process tank 56. The wastewater is pumped into the biological process tank by a pump 58. In the biological process tank 56 the waste water may be treated by known biological processes to remove biological contaminants.

The treated waste water is pumped from the biological process tank 56 to the filtration apparatus 2 via a pressurised sludge recirculation inlet 62 by use of a pump 60. A sludge recirculation outlet 66 is provided at the distal end of a pressurised cylindrical pressure vessel 4 of the filtration apparatus 2. An excess sludge outlet 64 is arranged between the filtration apparatus 2 and the biological process tank 56. A portion of the sludge is pumped back in the biological process tank 56 while another portion of the sludge may be collected in a sludge reservoir (not shown).

The sludge is being re-circulated in the pressure vessel 4 of the filtration apparatus 2. A plurality of membrane filter discs 6 are arranged in the pressure vessel. The membrane filter discs 6 are spaced from each other and are arranged along the length of a shaft 8. The shaft comprises a plurality of interconnected shaft portions 8′. The shaft 8 extends along the length of the pressure vessel 4 and is mechanically connected to a drive unit 32 formed as a motor. A number of membrane filter disc modules 30 are provided in the pressure vessel 4.

A bearing 18 is provided at the connection area of each set of adjacent membrane filter disc modules.

The permeate is discharged at the permeate outlet 50 located at the proximal end of the filtration apparatus 2 and the permeate flow 14′ through the permeate discharge channel in the shaft 8 is indicated in FIG. 4.

The longitudinal axis X of the pressure vessel 4 is laterally offset from the longitudinal axis Y of the shaft 8. Accordingly, when the membrane filter discs 6 are rotated a high cross flow is generated and thus fouling of the membranes can be reduced so that a higher permeate flow can be maintained.

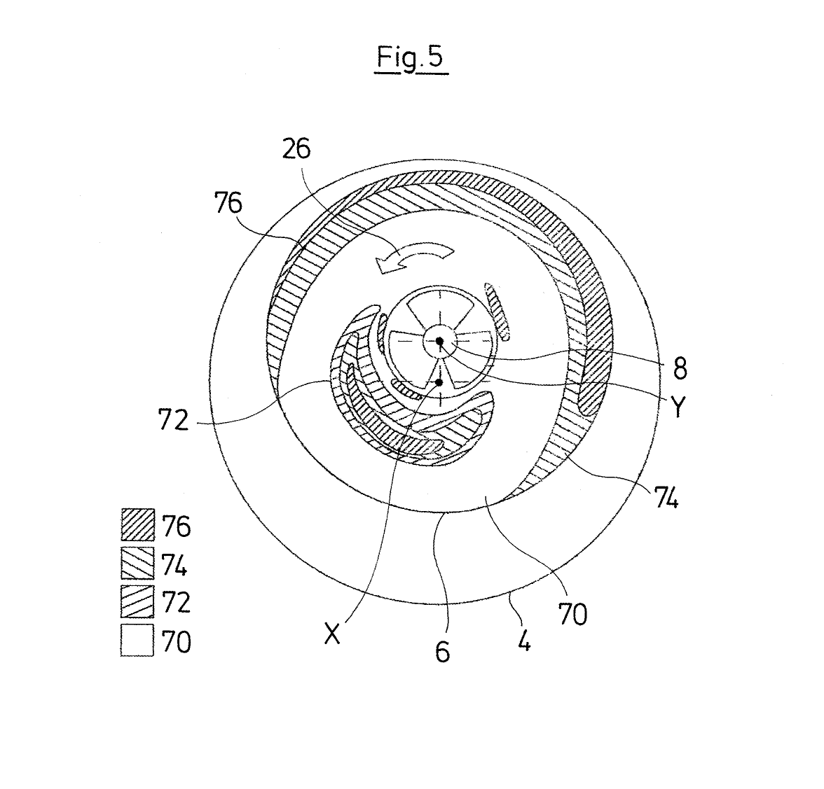

FIG. 5 illustrates a cross-sectional view of the filtration apparatus 2 according to a preferred embodiment of the present invention. A membrane filter disc 6 is arranged in a pressure vessel 4 and the membrane filter disc 6 is attached to a shaft 8. The rotation direction 26 of the shaft 8 is indicated as being counter clockwise.

The longitudinal axis X of the pressure vessel 4 is laterally offset from the longitudinal axis Y of the shaft 8. The shear stress on the surface of the membrane filter disc 6 in the areas A₁ and A₄ generated under rotation at a rotation frequency of 110 revolutions per minute (RPM) as indicated in FIG. 5. The shear stress on the surface of the membrane filter disc 6 is divided into four shear stress areas 70, 72, 74, 76 representing a shear stress of 6-12 Pascal (Pa), 12-14 Pa, 14-16 Pa and 16-18 Pa, respectively.

The highest shear stress area 76 is present at the periphery of the membrane filter disc 6 and at several minor areas at the central part of the membrane filter disc 6. The second largest stress area 74 is present close to the highest shear stress area 76.

FIG. 5 shows that increased shear stress can be generated so that fouling of the membranes can be reduced by laterally offsetting the longitudinal axis X of the pressure vessel 4 from the longitudinal axis Y of the shaft 8.

It is important to underline that increased shear stress also can be achieved by applying another frequency of a rotation of another direction of rotation. The example illustrated in FIG. 5 merely explains the effect of laterally offsetting the longitudinal axis X of the pressure vessel 4 from the longitudinal axis Y of the shaft 8.

A filtration apparatus 2 according to the invention is capable of reducing fouling on the membrane filter discs 6 by generation of high shear. Accordingly, a higher permeate flow can be maintained through the membrane filter discs 6.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A filtration apparatus (2) comprising:
a pressurised cylindrical pressure vessel (4) having a longitudinal axis (X);
a shaft (8) having a longitudinal axis (Y) extending parallel to the longitudinal axis (X) of the pressure vessel (4); and
a plurality of rotatable membrane filter discs (6) arranged along a length of the shaft (8), the membrane filter discs (6) being spaced-apart from each other, attached to the shaft (8) and oriented transverse to the longitudinal axis (Y) of the shaft (8), an interior (10) of the membrane filter discs (6) being in fluid communication with a permeate discharge channel (12),
wherein the longitudinal axis (X) of the pressure vessel (4) is laterally offset from the longitudinal axis (Y) of the shaft (8) or the membrane filter discs (6) are oval-shaped.

2. The filtration apparatus (2) according to claim 1, wherein the longitudinal axis (X) of the pressure vessel (4) is laterally offset from the longitudinal axis (Y) of the shaft (8) with a distance (E) corresponding to 2-20% of an inner diameter (D₃) of the pressure vessel (4).

3. The filtration apparatus (2) according to claim 1, wherein:
the shaft (8) comprises a plurality of interconnected shaft portions (8′);
the shaft (8) extends along a length of the pressure vessel (4); and
the shaft (8) is mechanically connected to a drive unit.

4. The filtration apparatus (2) according to claim 1, wherein a shortest distance (D₁) between the membrane filter discs (6) and an inner side of the pressure vessel (4) is less than half a longest distance (D₂) between the membrane filter discs (6) and the inner side of the pressure vessel (4) so that D₁<½D₂.

5. The filtration apparatus (2) according to claim 1, wherein one or more porous aeration pipes (28), extending approximately parallel to the longitudinal axis (X) of the pressure vessel (4), are arranged on an inner side of the pressure vessel (4).

6. The filtration apparatus (2) according to claim 1, further comprising:
a plurality of membrane filter disc modules (30) each consisting of a stack of the membrane filter discs (6); and
a bearing (18) provided at a connection area (34) of each of a set of adjacent membrane filter disc modules (30).

7. The filtration apparatus (2) according to claim 1, wherein a plurality of the membrane filter discs (6) constitute one or more modules (30) arranged in a chassis part (20) extending along a length of the pressure vessel (4).

8. The filtration apparatus (2) according to claim 4, wherein the membrane filter discs (6) are arranged in such a way that a line (L) that intersects a first filter disc point (P₁) that has the shortest distance (D₁) to the inner side of the pressure vessel (4) and that intersects a second filter disc point (P₂) that has the longest distance (D₂) to the inner side of the pressure vessel (4) defines:
a first 180 degree angular area comprising:
1) a first 90 degree angular area (A₁) abutting the first filter disc point (P₁);
2) a second angular area (A₂) abutting the first 90 degree angular area (A₁) and being present at a same side of the line (L) as the first 90 degree angular area (A₁); and
a second 180 degree angular area comprising:
3) a third 90 degree angular area (A₃) abutting the second 90 degree angular area (A₂) and being present at an opposite side of the line (L) as the second 90 degree angular area (A₂); and
4) a fourth degree angular area (A₄) extending between the third 90 degree angular area (A₃) and the first 90 degree angular area (A₁), wherein one or more porous aeration pipes (28) extend in the third 90 degree angular area (A3).

9. The filtration apparatus (2) according to claim 8, wherein no porous aeration pipes (28) extend in the first 90 degree angular area (A₁) or in the second 90 degree angular area (A₂).

10. The filtration apparatus (2) according to claim 1, wherein the pressure vessel (4) is configured to function as a membrane bioreactor (MBR) and one or more porous aeration pipes (28), extending approximately parallel to the longitudinal axis (X) of the pressure vessel (4) arranged on an inner side of the pressure vessel (4), are configured to aerate a fluid contained in the pressure vessel (4).

11. The filtration apparatus (2) according to claim 5, wherein the porous aeration pipes (28) are configured to release air bubbles in a size range of 2-40 μm.

12. The filtration apparatus (2) according to claim 1, wherein a rotational speed of the shaft (8) is between 100 and 250 RPM.
